(19) United States
(12) Patent Application Publication
(10) Pub. No.: US 2009/0123893 A1
(43) Pub. Date: May 14, 2009

(54) METHOD OF PERFORMING AND TEACHING ADHESIVE DENTISTRY

(76) Inventor: David S. Alleman, South Jordan, UT (US)

Correspondence Address: KARL R CANNON, PO BOX 1909, SANDY, UT, 84091, US

(21) Appl. No.: 12/350,214

(22) Filed: Jan. 7, 2009

Related U.S. Application Data
(63) Continuation-in-part of application No. 12/257,314, filed on Oct. 23, 2008.
Application No. 12/257,314 is a continuation of application No. 12/135,990, filed on Jun. 9, 2008.
(60) Provisional application No. 60/934,001, filed on Jun. 8, 2007.

(51) Int. Cl. A61C 5/00

(52) U.S. Cl. 433/215

(57) ABSTRACT

A method of restoring a tooth that includes applying a caries detecting stain to the central dentin of the tooth. Those portions of the central dentin that are stained with a deep stain indicative of decay are removed. Those portions of the central dentin that are stained with a light haze are left in tact such that the pulp of the tooth remains unexposed.

### CROSS-REFERENCE TO RELATED APPLICATIONS

This application is a continuation-in-part of U.S. application Ser. No. 12/257,314, filed Oct. 23, 2008, which is a continuation of U.S. application Ser. No. 12/135,990, filed Jun. 9, 2008, which claims the benefit of U.S. Provisional Application No. 60/934,001, filed Jun. 8, 2007, which are hereby incorporated by reference herein in its entirety, including but not limited to those portions that specifically appear hereinafter, the incorporation by reference being made with the following exception: In the event that any portion of the above-referenced applications are inconsistent with this application, this application supercedes said above-referenced application.

### STATEMENT REGARDING FEDERALLY SPONSORED RESEARCH OR DEVELOPMENT

Not Applicable.

### BACKGROUND

1. The Field of the Invention

The present disclosure relates generally to improved methods of performing and teaching adhesive dentistry.

2. Description of Related Art

Some conventional dentistry techniques for diagnosing and treating caries have seen little improvement since their initial development over 100 years ago. In particular, conventional dentistry techniques dictate that caries be diagnosed using visual inspection and tactile probing using handheld dental instruments, such as a dental mirror and sickle-shaped dental explorer. Dental radiographs, produced when x-rays are passed through the jaw and picked up on film or a digital sensor, may also facilitate the diagnosis of dental caries. Once diagnosed, the treatment of caries under conventional dentistry techniques involved removing the allegedly decayed region by drilling.

Once the decay is removed by the drilling, the missing tooth structure requires a dental restoration of some manner to return the tooth to functionality and aesthetic condition. This is typically done by mechanically securing a restorative material to the tooth. Restorative materials for replacing lost tooth structure may include, for example, dental amalgam, composite resin, porcelain and gold. When the decay is too extensive, there may not be enough tooth structure remaining to allow a restorative material to be placed within the tooth. Thus, a crown may be needed. This restoration appears similar to a cap and is fitted over the remainder of the natural crown of the tooth. Crowns are often made of gold, porcelain, or porcelain fused to metal.

When the restorative materials are used to replace tooth structure using conventional dentistry techniques, serious problems can occur. In particular, conventional dentistry techniques may cause the restorative material used on a repaired tooth to eventually fail, allowing bacteria to rot the tooth away from the inside. The failure of restorative materials applied using conventional dentistry techniques may be attributed, in some cases, to the techniques themselves. In particular, the techniques may be simply unsuitable for creating strong and long-lasting bonds between the tooth structure and the restorative materials.

Recent advancements over conventional dentistry techniques include the development of “adhesion dentistry.” Adhesion dentistry refers to various advanced techniques that utilize resin composites for the replacement of carious and fractured tooth structure. More modern techniques also enable restorative material to be added to the tooth for the correction of unaesthetic shapes, positions, dimensions, or shades. Resin composites can also be used to close diastemata, add length, or mask discoloration.

Adhesive techniques are also used to bond anterior and posterior ceramic restorations, such as veneers, inlays, and onlays. Adhesives can be used to bond silver amalgam restorations, to retain metal frameworks, to cement crowns and fixed partial dentures, to bond orthodontic brackets, for periodontal or orthodontic splints, to treat dentinal hypersensitivity, and to repair fractured porcelain.

Today, dentists in general practice are still exploring the possibilities of adhesive dentistry. Due to the relatively low costs and improved adhesive techniques, they are pushing the limits of resin composite restorations. However, many dental schools, especially in the U.S., are not teaching the most advanced techniques in regards to adhesive dentistry. Thus, potential failures in a repaired tooth may still occur even using the improved methods of adhesive dentistry. Therefore, there exists a need for improved methods of teaching adhesive dentistry.

Further, many dentists are reluctant to abandon conventional dentistry techniques. However, conventional dentistry techniques don't take advantage of the advanced ceramics and adhesives developed by modern engineering. These new technologies allow dentists to use small onlays that work more like a patient's own teeth rather than the large porcelain crowns used in traditional dentistry. Old techniques can cause teeth to eventually crack and leak, allowing bacteria to rot teeth away from the inside. Properly practiced adhesive dentistry as described herein locks out the bacteria, for safer, more durable dental work.

Further, in the past, adhesive dentistry techniques have resulted in weak bonds between the adhesive and tooth structure. That is, previous adhesive dentistry techniques fell short of achieving adequate bond strengths thereby resulting in high failure rates. These “weak” bonds have lead to failure when subjected to normal forces. Further, previously practiced adhesive dentistry techniques did not adequately prepare the tooth structure for an adhesive bond.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the discussion below.

### BRIEF DESCRIPTION OF THE DRAWINGS

The features and advantages of the disclosure will become apparent from a consideration of the subsequent detailed description presented in connection with the accompanying drawings in which:

FIG. 1 is an exemplary diagram illustrating a hierarchy for adhesive dentistry according to an embodiment of the present disclosure;

FIG. 2 is an exemplary flow diagram illustrating a useful method of teaching adhesive dentistry techniques;

FIGS. 3-6 depict an exemplary flow diagram illustrating a useful method for repairing a subject tooth pursuant to an embodiment of the present disclosure;

FIG. 7 depicts a subject tooth repaired according to an embodiment of the present disclosure; and

FIG. 8 depicts a top view of a subject tooth in the process of being repaired according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure from the subject matter disclosed in the reference materials.

It must be noted that, as used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps. The following publication is hereby incorporated by reference in its entirety as if fully set forth herein: Fundamentals of Operative Dentistry, 3^{rd} Edition, Quintessence Publishing Co., Inc. (2006).

Turning now to the aspects of the present disclosure, the applicant has devised a novel hierarchical relationship of information and techniques regarding the teaching and practice of adhesive dentistry. The hierarchical relationship facilitates the presentation and understanding of the latest advancements in adhesive dentistry. The hierarchical relationship further enables the presentation of the complex scientific principles of adhesive dentistry in an effective manner to dental practitioners.

The applicant has further discovered a novel training method and curriculum to teach the latest techniques for adhesion dentistry. The training method is specifically designed for practicing dentists, but may also be appropriate for dental researches and academics. The training method and curriculum may comprise six lessons that incorporate and present, in an organized fashion, the hierarchical relationship developed by the applicant. The training method may include preparatory reading of selected scientific papers that outline the principles and relationships important to adhesion dentistry. The training method may further include a visual presentation. At the end of the training, a participant will have an improved understanding of modern techniques for adhesive dentistry and the underlying scientific principles fundamental to a successful practice of adhesion dentistry. By incorporating the techniques and scientific principles taught by the applicant's curriculum, dentists and other practitioners employing will enjoy a significant reduction in the number of failures of adhesive bonds. This will result in increased patient satisfaction.

The applicant has further devised novel improvements to the currently known adhesive dentistry techniques that may result in dental bonds that more effectively treat weak, fractured, and decayed teeth in a manner that provides enhanced strength and seals them from bacterial invasion. In some instances, the applicant's improved techniques disclosed herein may remove the need for 60% to 90% of the crowns and root canals of conventional dentistry. These new methods developed by the applicant may allow dental practitioners to use smaller onlays that work more like real teeth rather than the large crowns typical in conventional dentistry. Further, the techniques disclosed herein may ensure that in the event that a failure does occur, it will occur in a repairable way and before tooth structure suffers any biological failure. In particular, the applicant's novel techniques for repairing teeth may provide a more effective seal against infection thereby making sure that more serious dental problems do not arise, even in the event of material failure.

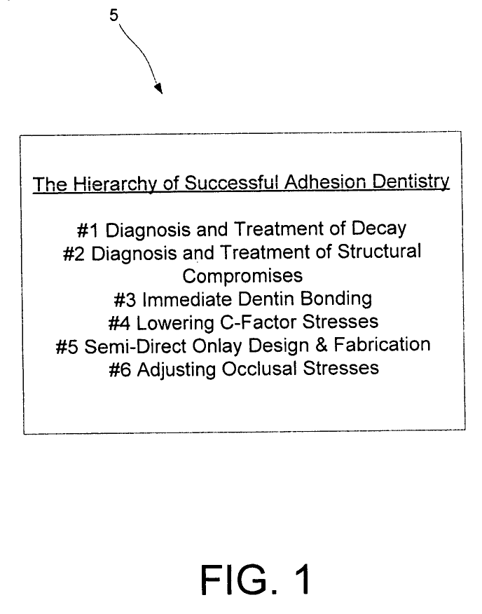

Referring now to FIG. 1, there is depicted a hierarchy 5 of the techniques and understanding required for the successful practice of adhesion dentistry pursuant to the present disclosure. As will be noted, the hierarchy comprises six (6) levels or main concepts, including:

Level #1 Diagnosis and Treatment of Decay;

Level #2 Diagnosis and Treatment of Structural Compromises;

Level #3 Immediate Dentin Sealings;

Level #4 Lowering C-Factor Stresses;

Level #5 Semi-Direct Onlay Design & Fabrication; and

Level #6 Occlusal Adjustment of Stresses.

The above hierarchy 5 is fundamental to the successful use of adhesion dentistry. Each level of the hierarchy 5 will be discussed in detail below.

### Level #1: The Diagnosis and Treatment of Decay

The diagnosis and proper treatment of caries is critical to successful adhesion dentistry. The presence of caries results in weakened adhesive bonds and ultimately leakage. There are four (4) primary methods to diagnose decay that form a part of the present disclosure, including: explorers, caries detecting dyes, drying techniques, and light probes. A suitable light probe for use with the present disclosure may include a DIAGNOdent® laser-light probe. These four (4) primary methods may be employed to diagnose decay prior to applying adhesive to tooth structures. The following publications, which are hereby incorporated by reference in their entireties, illustrate techniques for diagnosing decay: Fusayama, “Clinical guide for removing caries using a caries-detecting solution”, Quintessence International 1988; 19:397-401; Lussi et. al., “DIAGNOdent: An Optical Method for Caries Detection”, Journal of Dental Research (2004) 83 (Spec Issue C): C80-C83; Boston & Sauble, “Evaluation of laser fluorescence for differentiating caries dye-stainable versus caries dye-unstainable dentin in carious lesions”, American Journal of Dentistry 2005: 18:351-354; Knight & Craig, “An in vitro model to measure the effect of a silver fluoride and potassium iodide treatment on the permeability of demineralized dentine to Streptococcus mutans”, Australian Dental Journal 2005: 50: (4): 242-245.

### Level #2: Diagnosis and Treatment of Structural Compromises

The proper diagnosis and treatment of structural comprises in a tooth may decrease the stress on tooth structures. Every tooth has a complex internal structure; density gradients and seams that inflexible crowns and inept drilling can crack open. Avoiding structural compromise through precisely shaping the teeth may keep them from cracking under occlusional stresses. In particular, the applicant has discovered four (4) “red flags” that may dictate when an indirect or semi-direct restoration should be used in lieu of a direct restoration. In particular, a direct restoration may only be used when there is (1) no crack into the dentin of a tooth; (2) the isthmus width is about 2 mm or less; (3) the estimated cusp thickness (measured faciolingually at the base of a cusp, e.g., the floor of the prep) is no less than about 3 mm; and (4) the proximal box depth is less than about 4 mm. If any of the above “red flags” are not satisfied, an indirect or semi-direct restoration should be utilized instead of a direct restoration. Failure to notice a “red flag” may ultimately result in a bond or tooth failure at some later time.

The following publications, which are hereby incorporated by reference in their entireties, illustrate techniques of diagnosing and treating structural comprises in accordance with the present disclosure: Larson, Douglas & Geistfeld, “Effects of Prepared Cavities on the Strength of Teeth”, OPERATIVE DENTISTRY 1981: 6: 2-5; Milicich & Rainey, “Clinical Presentations of Stress Distribution in Teeth and the Significance in Operative Dentistry”, Pract Perio & Aesthet Dent 2000: 12(7):695-700; and Fennis, et al, “Fatigue Resistance of Teeth Restored with Cuspal-Coverage Composite Restorations” Mt J Prosthod 2004: 17:313-317.

### Level #3: Immediate Dentin Sealings

The applicant has discovered that bonding to dentin may be successfully accomplished if a dental practitioner (1) uses a caries detector properly; (2) understands the significance of a “light haze” generated by a caries detecting dye; (3) uses a computerized caries detector, such as a laser-light probe, e.g., DIAGNOdent®, on dentin; (4) uses a Matrix Metalloproteinase (“MMP”) deactivator, such as chlorhexidine, e.g., Concepsis®, on dentin; (5) uses an appropriate dentin bonding adhesive, such as Clearfil Protect Bond®, Clearfil SE Bond®, OptiBond® FL, and Prelude. Proper bonding to dentin seals the dentin from harmful bacteria known to cause decay. The following publications, which are hereby incorporated by reference in their entireties, illustrate techniques of bonding to dentin in accordance with the present disclosure: Magne, et al, “Immediate dentin sealing improves bond strength of indirect restorations” Journal of Prosthetic Dentistry 2005; 94:511-519; Dietschi, et al, “Marginal and internal adaptation of class II restorations after immediate or delayed composite placement”, Journal of Dentistry 2002 (30): 259-269; Pashley, et al, “Collagen Degradation by Host-derived Enzymes during Aging”, J Dent Res 2004 (83) 3: 216-221; and Donmez, Belli, Pashley & Tay, “Ultrastructural Correlates of in vivo/in vitro Bond Degradation in Self-etch Adhesives”, J Dent Res 2005 (84) 4: 355-359.

### Level #4: Lowering C-Factor Stresses

A high C-factor results in higher bond stress. Therefore, a dental practitioner should strive to recognize situations where a high C-factor is present. Traditionally, what was referred to as a “minimally invasive prep” of a tooth may in fact have a high C-factor. The following publications, which are hereby incorporated by reference in their entireties, illustrate the various methods of lowering stress caused by a high C-factor in accordance with the present disclosure: Feilzer, De Gee & Davidson, “Setting Stress in Composite Resin in Relation to Configuration of the Restoration”, J Dent Res 1987 (66) 11:1636-1639; Cho, et al, “Effect of Interfacial Bond Quality on the Direction of Polymerization Shrinkage Flow in Resin Composite Restorations”, OPER DENT 2002 (27) 297-304; Wilson, et al, “A Clinical Evaluation of Class II Composites Placed Using a Decoupling Technique” J Adhesive Dent 2000 (2); 319-329; Dietschi, et al, “In vitro evaluation of marginal and internal adaptation after occlusal stressing of indirect class II composite restorations with different resinous bases”, Eur J Oral Sci 2003 (111):73-80; Belli, et al, “The Effect of C-Factor and Flowable Resin or Fiber Use at the Interface on Microtensile Bond Strength to Dentin”, J Adhes Dent 2006 (8) 247-253; Uno, et al, “Effect of slow-curing on cavity wall adaptation using a new intensity-changeable light source” Dental Materials 2003 (19) 147-152; Nikolaenko, et al, “Influence of C-Factor and layering Technique on microtensile bond strength to dentin”, Dental Materials 2004 (20): 579-585.

### Level #5: Semi-Direct Onlay Design & Fabrication

A dental practitioner may already be familiar with semi-direct onlay design and fabrication. The following publications, which are hereby incorporated by reference in their entireties, illustrate the various methods of semi-direct onlay design and fabrication: Opdam, et al, “Necessity of bevels for box only Class II composite restorations” J Prosth Dent 1998 (80):274-279; Ausiello, et al, “Stress distributions in adhesively cemented ceramic and resin-composite Class II inlay restorations: a 3-D FEA study”, Dental Materials 2004 (20): 862-872; and Asmussen & Peutzfeldt, “The effect of Secondary Curing of Resin Composite on the Adherence of Resin Cement” J Adhesive Dent 2000 (2):315-318.

### Level #6: Adjusting Occlusal Stresses

A dental practitioner may already be familiar with adjusting occlusal stresses. The following publications, which are hereby incorporated by reference in their entireties, illustrate the various methods of adjusting occlusal stresses: Fennis, et al, “In vitro fracture resistance of fiber reinforced cusp-replacing composite restorations”, Dental Materials 2005 (21):565-572; Gibbs, et al, “Limits of human bite strength”, J Prosth Dent 1986 (56): 226-229; and Magne & Belser, “Rationalization of Shape and Related Stress Distribution in Posterior Teeth” Int J Perio Rest Dent 2002 (22):425-433.

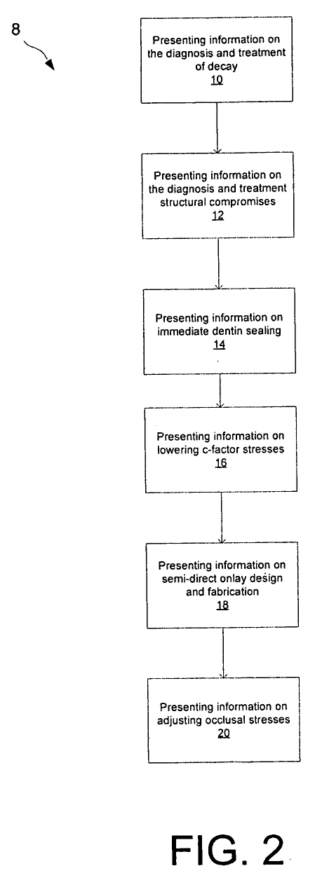

Referring now to FIG. 2, there is depicted a flow diagram 8 according to an embodiment of the present disclosure. At step 10, dental practitioners may be presented with information on the diagnosis and treatment of decay. This information may include the information in Level 1 of the hierarchy 5 described above (see FIG. 1). At step 12, dental practitioners are presented with information on the diagnosis and treatment of structural compromises. This information may include the information in Level 2 of the hierarchy 5 described above (see FIG. 1).

At step 14, dental practitioners are presented with information on immediate dentin sealing. This information may include the information in Level 3 of the hierarchy 5 described above (see). At step 16, dental practitioners are presented with information on lowering C-factor stresses. This information may include the information in Level 4 of the hierarchy 5 described above (see). At step 18, dental practitioners are presented with information on semi-direct onlay design and fabrication. This information may include the information in Level 5 of the hierarchy 5 described above (see). At step 20, dental practitioners are presented with information on adjusting occlusal stresses. This information may include the information in Level 6 of the hierarchy 5 described above (see). In addition to the steps 10-20 shown in FIG. 2, the dental practitioners may be presented with information on adhesive dentistry. Such information may include the information found in the following publications, which are hereby incorporated by reference in their entireties: Unterbrink & Liebenberg, “Flowable composites as filled adhesives”, Quintessence International 1999; 30:249-257; Versluis et. al., “Residual shrinkage stress distribution in molars after composite restoration”, Dental Materials (2000) 20, 554-564; and Brannstrom, “The Hydrodynamic Theory of Dental Pain Sensation in Preparation, Caries, and the Dental Crack Syndrome”, Journal of Endodontics 1986 vol 12 #10:453-457.

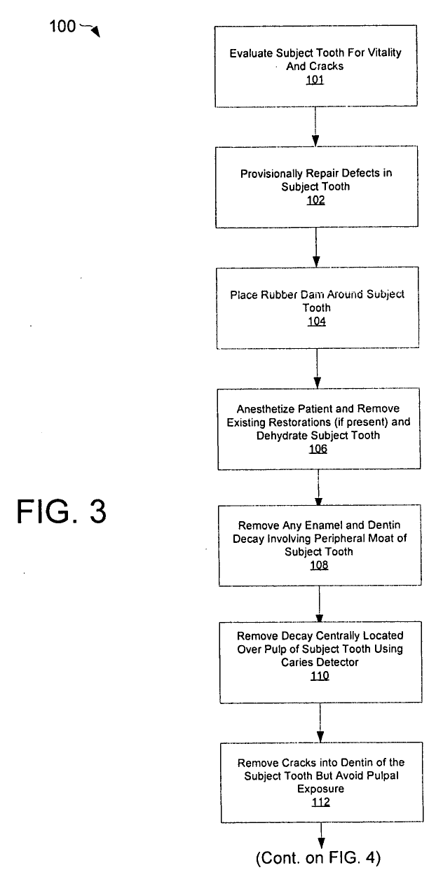

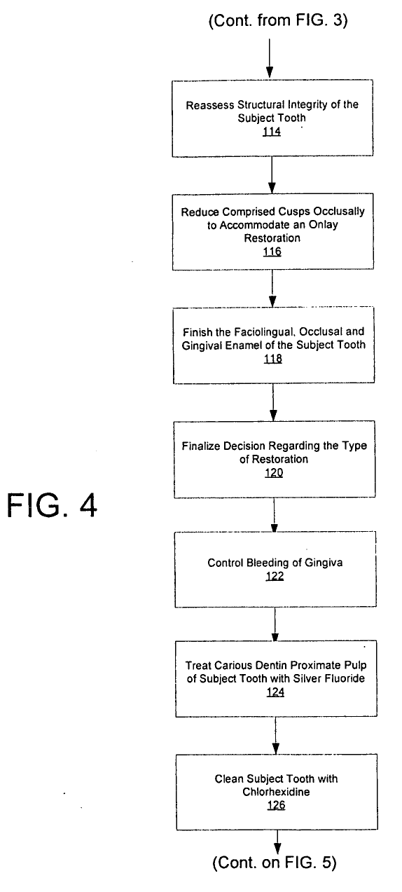

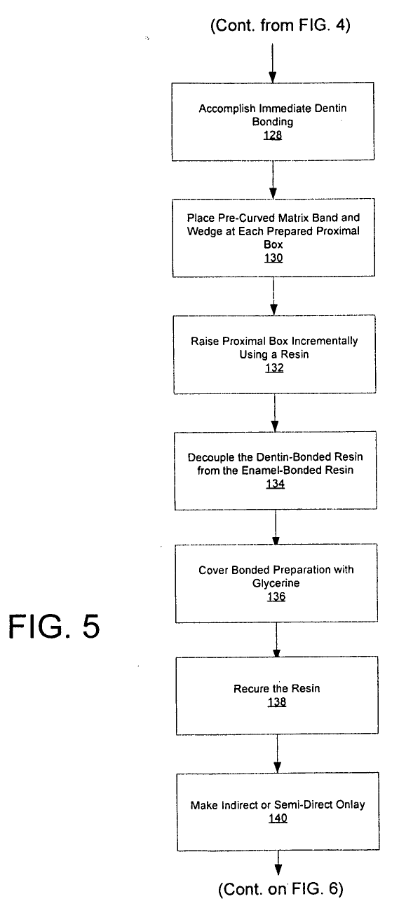

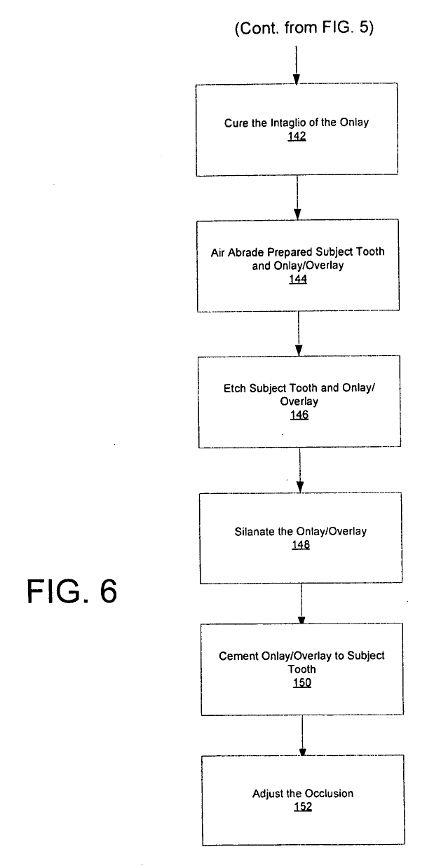

Referring now to FIGS. 3-6, there is depicted a flow diagram 100 of a method for restoring a tooth pursuant to an embodiment of the present disclosure. A step 101, a subject tooth may be evaluated for vitality (cold test) and cracks into dentin (visual and fiberoptic light). A direct restoration may be advisable when there is (1) no crack into the dentin of a tooth; (2) the isthmus width is about 2 mm or less; (3) the estimated cusp thickness (measured faciolingually at the base of a cusp, e.g., the floor of the prep) is no less than about 3 mm; and (4) the proximal box depth is less than about 4 mm. If any of the above are not satisfied, an indirect or semi-direct restoration may be utilized instead of a direct restoration.

At step 102, a dental practitioner may provisionally repair any defects of the subject tooth to be restored and take a quadrant impression utilizing a rimless tray and an appropriate dental substance, such as Star VPS Clear Bite, then set it aside. This may include pouring the impression with a fast set, such as Snapstone, and making a thick plastic clear overlay stent. At step 104, a rubber dam may be placed around the subject tooth. At step 106, the dental practitioner may anesthetize the patient and remove the existing restoration (if present) and dehydrate (drying) the subject tooth to search for demineralized enamel and any enamel cracks penetrating the dentin-enamel bond (“DEJ”).

At step 108, the dental practitioner may remove any enamel and dentin decay involving the peripheral moat of the subject tooth. If decay extends apically beyond the cemento-enamel junction (“CEJ”), the dental practitioner may create a butt gingival margin in the proximal box. This step may further include the dental practitioner utilizing a caries detection dye or stain, such as Caries Finder, in conjunction with a computerized caries detection device, such as DIAGNOdent®. In an embodiment of the present disclosure, the dental practitioner may remove decay until a maximum DIAGNOdent® reading of about twelve (12) in the peripheral moat dentin is achieved.

At step 110, the dental practitioner may remove decay centrally located over the pulp of the subject tooth. This step may further include the dental practitioner utilizing a caries detection dye or stain, such as Caries Finder, in conjunction with a computerized caries detection device, such as DIAGNOdent®. If Caries Finder and DIAGNOdent® are utilized, the dental practitioner may carefully remove all diseased areas stained red but leaving any areas stained with a light pink haze. In particular, if Caries Finder and DIAGNOdent® are utilized, a light pink haze (no red) and a DIAGNOdent® reading of between 24-36, or less, may establish the terminal depth of carious dentin removal. At step 112, the dental practitioner may attempt to remove all cracks into the dentin of the subject tooth, but avoid a pulpal exposure, if at all possible.

At step 114, the dental practitioner may reassess the degree to which the subject tooth is structurally compromised by measuring the residual cusp(s) thickness at the base of each cusp (2.5 to 3 mm or more). At step 116, the dental practitioner may reduce each compromised cusp 2-3 mm occlusally to accommodate an onlay restoration.

At step 118, the dental practitioner may finish the faciolingual enamel according to Boyde's lines, the occlusal enamel according to Uribe's angles and proximal box (gingival) enamel with Opdam's bevels. With improved access to the proximal boxes, retest the prepared enamel and dentin to assure a DIAGNOdent® maximum readings of about 12, or less, in moat dentin and 24-36, or less, in central dentin. At step 120, the dental practitioner may finalize the decision regarding the type of restoration, e.g., direct vs indirect, and specifically, whether a direct inlay, semi-direct onlay or an indirect overlay may be appropriate.

At step 120, the dental practitioner may decide on the material for final restoration. This material may include a composite material, such as Clearfil Majesty® Posterior, if restored chair side. At step 122, the dental practitioner may control bleeding of gingiva if necessary. The dental practitioner may utilize electrosurgery (cautery setting), lidocaine 1:50,000, Superoxol or Viscostat Clear (after the use of Viscostat, the dental practitioner may rinse vigorously and re-prep the moat).

At step 124, if carious dentin encroaches the pulp and has a DIAGNOdent® reading of greater than about 24-36, the dental practitioner may treat the carious dentin with AgF (silver fluoride). To avoid staining, the dental practitioner may utilize a tiny amount of 1.8 molar AgF and immediately flush the dentin with a copious amount of saturated solution of KI (potassium iodide). The dental practitioner may then rinse the dentin thoroughly and refine the moat of the preparation. A rubber dam isolation may be essential for this step, plus the dental practitioner may use extreme care in handling the AgF, to avoid undesirable stains.

At step 126, the dental practitioner may clean the subject tooth with chlorhexidine, e.g., Consepsis®, for 30 seconds to deactivate MMPs that would degrade bond strength; then the dental practitioner may dry the tooth well. At step 128, the dental practitioner may accomplish immediate dentin bonding. This may be accomplished by the dental practitioner applying a primer for 30 seconds with a brush and then drying the tooth 10 seconds. Once the tooth has been dried, the dental practitioner may then apply adhesive with a brush. Any excess adhesive may be removed with a dry micro-brush. The adhesive may be cured for about 20 seconds.

At step 130, the dental practitioner may place a pre-curved matrix band and wedge at each prepared proximal box and coat the box(es) and occlusal dentin with a thin (0.5 mm) layer of either Heliomolar Flow or Clearfil Majesty® Flow, incorporating a woven fiber material, such as Ribbond®, on the axial and pulpal wall layers as necessary, to reduce C-Factor stress and to restore structural integrity. The resin may be cured for about 30 seconds.

At step 132, the dental practitioner may raise the proximal box approximately 2 mm, incrementally, with a resin, such as Clearfil AP-X®. The dental practitioner may slow-cure the resin utilizing a radiometer-calibrated halogen light or equivalent light as follows: 1) 20 seconds at 230 mw/cm² with the light tip at the calibrated distance from the resin surface; 2) Light off for 10 seconds; 3) 20 seconds at 600 mw/cm² with the light tip the calibrated distance from the resin surface.

At step 134, the dental practitioner may decouple the dentin-bonded resin from the enamel-bonded resin by waiting a minimum of five (5) minutes before bonding the raised box resin to a direct inlay occlusal resin. The dental practitioner may wait thirty (30) minutes to two (2) weeks before bonding the occlusal portion of a semi-direct or indirect overlay restoration. At step 136, if an indirect or semi-direct restoration is chosen, the dental practitioner may cover the bonded preparation with glycerine to overcome the oxygen-blocked cure of the final 50 microns of resin. At step 138, the resin may then be re-cured for twenty (20) seconds at 600 mw/cm².

At step 140, the dental practitioner may make a CEREC indirect onlay or a semi-direct onlay (block out undercuts apical to preparation with Dam Cool, then cure it). The dental practitioner may utilize the Star VPS Clear Bite pre-prep impression tray and then fill the prepared tooth area with Majesty Posterior resin (warmed up to 100° F. to significantly increase its flow characteristics) and place Teflon® tape, K-Y® Jelly or Liquid Lens as a separating medium on the preparation. Once the tray is seated, the dental practitioner may instruct the patient to close tightly, and initially chairside-cure the semi-direct onlay facially and occlusally for twenty (20) seconds each. Or, for an indirect overlay, the dental practitioner may take a First Quarter Monophase FS 1.75 minutes-set time quadrant impression that includes the preparation, and make a SnapStone model; block out undercuts with Dam Cool (then cure it) and firmly press 100° F. warmed-up Majesty Posterior resin at the appropriate tooth in the First Quarter Monophase FS impression tray and firmly press it onto the stone model. The dental practitioner may then remove the tray and cure the indirect only restoration for forty (40) seconds.

At step 142, the dental practitioner may cure the intaglio (preparation side of the restoration) of either the Wendell semi-direct onlay or SnapStone indirect overlay for an additional 20 seconds at 450 mw/cm². The dental practitioner may then “cook” the partially cured semi-direct only or indirect onlay restoration for about seven (7) minutes in an oven set to 250° F. At step 144, the dental practitioner may air abrade both the prepared tooth and the onlay/overlay utilizing 50 micron Aluminum Oxide in a microetcher.

At step 146, the dental practitioner may etch the tooth and the onlay/overlay with liquid phosphoric acid (such as Danville's Sure Etch Liquid) for five (5) seconds. The dental practitioner may then rinse and dry both the restoration and the tooth. At step 148, the dental practitioner may silanate the onlay/overlay with a combination of Clearfil SE Bond® Primer and Clearfil® Porcelain Bond Activator. At step 150, the dental practitioner may place a pre-curved premier matrix band around the prepared tooth, plus a wedge at each raised box. The dental practitioner may then cement the onlay utilizing either Bottle #2 of Kerr OptiBond Fl®, Clearfil SE Bond® or Clearfil Protect Bond® on the onlay and the tooth and Danville's Accolade flowable composite. Then, the dental practitioner may cure them together; or use Kuraray Dental's PANAVIA F 2.0. The dental practitioner may utilize a variety of tools and disposables to remove flash, smooth margins and polish the final restoration, such as Profin tips, Dura White stones, finishing strips, etc.

At step 152, the dental practitioner may adjust the occlusion with the patient in the upright chair position. This step may utilize the Unterbrink Power Clench technique to detect balancing interferences, e.g., place one paper on the unprepared arch, such as the right side, instructing the patient to chew; then, additionally place two papers on the restored arch, e.g, the left side, instructing the patient to close firmly. The dental practitioner may then examine for balancing interferences on the new restoration. If the anesthesia has not worn off, the dental practitioner may have the patient return the next day for final occlusal equilibration and polishing of the restoration.

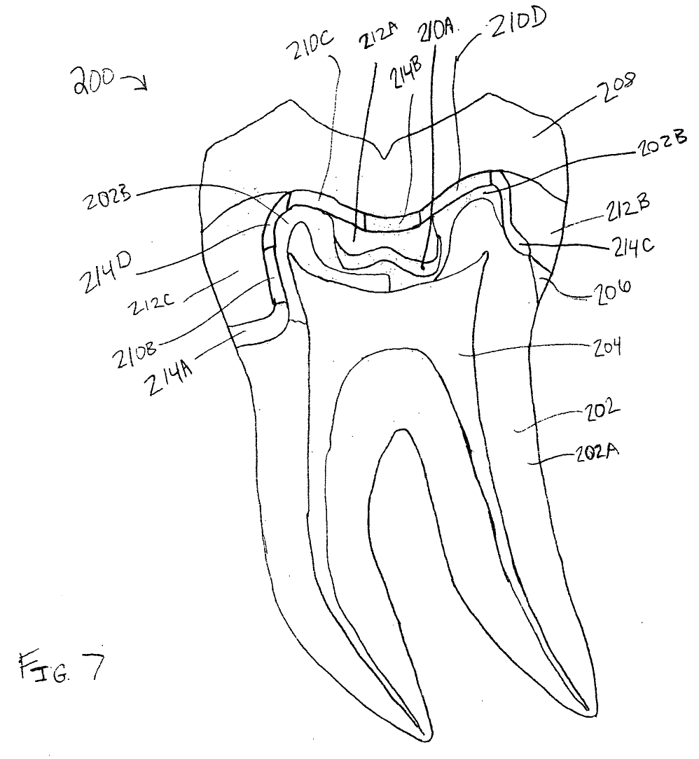

Referring now to FIG. 7, there is depicted a tooth 200 restored using the methods of the present disclosure. The tooth 200 may comprise dentin 202, pulp 204, and enamel 206. The dentin 202 may comprise a first portion 202A that is superficial dentin that is unstained by a caries detecting dye. The dentin 202 may comprise a second portion 202B that is stained by a caries detecting dye, but not to a sufficient degree to warrant removal. A third portion of the dentin 202 may have been stained by a caries detecting dye to a sufficient degree to warrant removal and is therefore not shown in FIG. 7 as it has already been removed by the dental practitioner. A woven fiber material 210A, such as Ribbond®, may be adhered with a dental restorative material, such as Heliomolar®, to the second portion 202B of the dentin 202. A dental composite material 212A, such as Composite (AP-X), may be applied over the woven fiber material 210A to raise the central portion of the tooth 200.

A dental restorative material 210A, such as Heliomolar®, may be applied along a surface of the first portion 202A of the dentin 202. A woven fiber material 210B, such as Ribbond®, may be adhered with a dental restorative material, such as Heliomolar®, to the second portion 202B of the dentin 202 in a high C-factor area. A woven fiber material 210B and 210C, such as Ribbond®, may be adhered with a dental restorative material, such as Heliomolar®, to the second portion 202B of the dentin 202, in particular over the central dentin of the tooth 200. A dental restorative material 214C and 214D, such as Heliomolar®, may be applied along a surface of the second portion 202B of the dentin 202. A dental restorative material 214B, such as Heliomolar®, may be applied along a top surface of the dental composite material 212A. The peripheral edges of the box may be raised using a dental composite material 212B and 212C. An onlay 208 may be adhered to the tooth 200 as shown in FIG. 7.

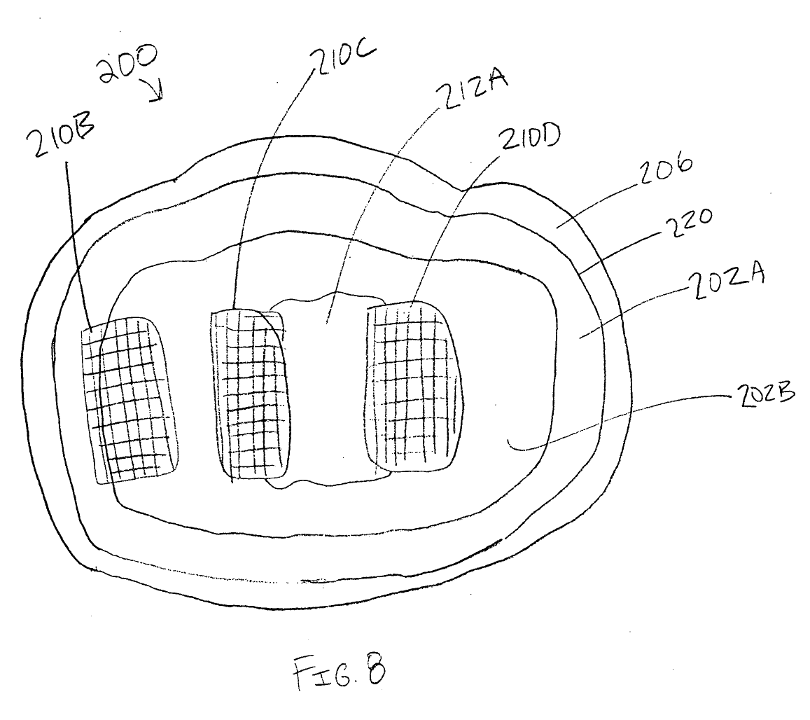

Referring now to FIG. 8, there is depicted a top view of the tooth 200 prior to the installation of the onlay 208. In particular, there is shown an outer ring of enamel 206, a dentino enamel junction 220, a peripheral “moat” or “ring” of the first portion 202A of the dentin 202, and a second portion 202B of the dentin 202 and the dental composite material 212A. The woven fiber material 210B is placed over a high C-factor box area. The woven fiber material 210C and 210D is placed over the central dentin.

The tooth 200 depicted in FIGS. 7 and 8 may be prepared utilizing the steps as shown an described in relation to FIGS. 3-6. In particular, it will be noted that if Caries Finder and DIAGNOdent® are utilized, the dental practitioner may carefully remove all diseased areas stained red in the enamel 206, the dentino enamel junction 220, the peripheral “moat” or “ring” of the first portion 202A of the dentin 202, and the second portion 202B of the dentin 202. In addition, all areas stained in a light pink haze may be removed from the enamel 206, the dentino enamel junction 220, the peripheral “moat” or “ring” of the dentin 202A. However, any light pink haze in the central dentin 202B is left in place so as not to compromise the structure of the tooth 200. In addition, any enamel “white spots” after dehydration may be removed from the enamel 206.

The following Table 1 indicates the action for each area of a subject tooth that has had a caries detecting dye applied according to an embodiment of the present disclosure.

TABLE 1

| | | Dentino | | Deep or | |
|---|---|---|---|---|---|
| | | Enamel | Superficial | Central | |
| | Enamel | Junction | Dentin | Dentin | Pulp |
| Deep | Remove | Remove | Remove | Remove | Do Not |
| Stain | | | | | Remove, |
| | | | | | Treat with |
| | | | | | AgF |
| Light | Remove | Remove | Remove | Do Not | Do Not |
| Haze | | | | Remove | Remove |
| White | Remove | N/A | N/A | N/A | N/A |
| Spots | | | | | |

In an embodiment of the present disclosure, a deep stained area of a tooth may have a DIAGNOdent® reading of greater than about 24-36. A light hazed area may have a DIAGNOdent® reading of less than about 24-36. In an embodiment of the present disclosure, an area stained in a “light haze” by a caries detecting dye may be minimally stained but not infected and an area stained in a deep stain by a caries detecting dye may actually be infected or decayed. A difference between an area stained with a “light haze” and a “deep stain” may be determined by visual inspection.

In accordance with the features and combinations described above, a useful method of teaching techniques suitable for use with adhesive dentistry in accordance with an embodiment of the present disclosure comprises the steps of:

(a) presenting information on the diagnosis and treatment of decay;

(b) presenting information on the diagnosis and treatment structural compromises;

(c) presenting information on immediate dentin sealing;

(d) presenting information on lowering C-factor stresses;

(e) presenting information on semi-direct onlay design and fabrication; and

(f) presenting information on adjusting occlusal stresses.

In one embodiment, the order of presentation of the steps above, is step (a), step (b), step (c), step (d), step (e) and step (f). Other embodiment may present the above steps in any order.

In accordance with the features and combinations described above, a useful method of repairing a tooth, said tooth comprising enamel, dentin and pulp, comprises the steps of:

(a) attempting to remove all cracks in the dentin of the tooth, but avoiding pupal exposure, if possible;

(b) leaving a light haze of a caries detector in the dentin located centrally over the pulp;

(c) assessing a degree of structural compromise by measuring cusp thickness;

(d) reducing each comprised cusp occlusally to accommodate onlay restoration;

(e) permitting a maximum fluorescence reading of a predetermined amount in moat dentin;

(f) permitting a maximum fluorescence reading of a predetermined amount in central dentin; and

(g) treating carious dentin near or encroaching the pulp with a fluorescence reading of greater than a predetermined amount with silver fluoride.

In accordance with the features and combinations described above, a useful method of repairing a tooth, said tooth comprising enamel, dentin and pulp, comprises the steps of:

(a) attempting to remove all cracks in the dentin of the tooth, but avoiding pupal exposure, if possible;

(b) leaving only a light haze of a caries detector having a fluorescence reading of about 24-36 or less in the central dentin;

(c) assessing a degree of structural compromise by measuring cusp thickness;

(d) reducing each comprised cusp occlusally to accommodate onlay restoration;

(e) permitting a maximum fluorescence reading of 12 in moat dentin;

(f) permitting a maximum fluorescence reading of 24-36 in central dentin; and

(g) treating carious dentin encroaching the pulp with a fluorescence reading of greater than about 24-36 with silver fluoride.

In accordance with the features and combinations described above, a useful method of repairing a tooth, said tooth comprising enamel, dentin and pulp, comprises the steps of:

(a) placing a premier pre-curved matrix band and wedge at a prepared proximal box;

(b) placing about a 0.5 mm layer of resin, such as Heliomolar® Flow or Clearfil Majesty® Flow, in the box and, optionally, over the occlusal dentin;

(c) incorporating one or more squares of a fiber reinforcement, such as Ribbond®, firmly against the dentin; and

(d) curing for at least thirty (30) seconds.

In accordance with the features and combinations described above, a useful method of repairing a tooth, said tooth comprising enamel, dentin and pulp, comprises the steps of:

(a) preparing a proximal box;

(b) incrementally raising the proximal box by applying a resin, such as Clearfil AP-X® resin;

(c) allowing the resin to cure slowly; and

(d) waiting a minimum of about five (5) minutes to about two (2) weeks between bonding the resin in the raised portion of the proximal box to an occlusal portion of the restoration.

In accordance with the features and combinations described above, a useful method of repairing a tooth, said tooth comprising enamel, dentin and pulp, comprises the steps of:

(a) preparing a proximal box;

(b) incrementally raising the proximal box by applying a resin, such as Clearfil AP-X® resin;

(c) allowing the resin to cure slowly;

(d) waiting a minimum of about five (5) minutes to about two (2) weeks between bonding the resin in the raised portion of the proximal box to an occlusal portion of the restoration; and

(e) covering the resin with glycerine, such as Liquid Lens, to overcome any oxygen-blocked cure of an outermost layer of the resin.

Those having ordinary skill in the relevant art will appreciate the advantages provide by the features of the present disclosure. For example, it is a feature of the present disclosure to provide an improved method of teaching adhesive dentistry. Another feature of the present disclosure to provide information on the most recent techniques of adhesive dentistry. It is a further feature of the present disclosure, in accordance with one aspect thereof, to provide an improved technique for adhesion dentistry.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment.

It is to be understood that the above-described arrangements are only illustrative of the application of the principles of the present disclosure. Numerous modifications and alternative arrangements may be devised by those skilled in the art without departing from the spirit and scope of the present disclosure. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of restoring a tooth, said tooth comprising a pulp, enamel and dentin, the dentin comprising a peripheral moat and central dentin, said central dentin of the tooth being disposed over the pulp of the tooth, said method comprising the steps of:
applying a caries detecting stain to the central dentin of the tooth;
removing portions of the central dentin that are stained with a deep stain indicative of decay; and
leaving intact portions of the central dentin that are stained with a light haze.

2. The method of claim 1, further comprising the step of removing all cracks into the dentin.

3. The method of claim 1, further comprising using a light probe to measure a fluorescence of the stain.

4. The method of claim 1, further comprising applying a direct restoration only if an isthmus width of the tooth is about two millimeters or less.

5. The method of claim 4, further comprising applying a direct restoration only if an estimated cusp thickness is no less than about three millimeters.

6. The method of claim 5, further comprising applying a direct restoration only if a proximal box depth is less than about four millimeters.

7. The method of claim 1, further comprising applying an indirect or semi-direct restoration if an isthmus width of the tooth greater than about two millimeters.

8. The method of claim 7, further comprising applying an indirect or semi-direct restoration if an estimated cusp thickness of the tooth is less than about three millimeters.

9. The method of claim 8, further comprising applying an indirect or semi-direct restoration if a proximal box depth is greater than about four millimeters.

10. The method of claim 1, further comprising reducing compromised cusps occlusally.

11. The method of claim 1, further comprising treating decay that encroaches the pulp with a silver fluoride solution.

12. A method of restoring a tooth, said tooth comprising a pulp, enamel and dentin, the dentin comprising a peripheral moat and central dentin, said method comprising the steps of:
applying a caries detecting stain to the enamel and the dentin of the tooth;
removing portions of at least one of the dentin and enamel that are stained with a deep stain indicative of decay;
bonding a resin to the dentin;
bonding a resin to the enamel; and
decoupling the dentin-bonded resin from the enamel-bonded resin.

13. The method of claim 12, wherein said tooth comprises a proximal box, and said method further comprises the step of raising a portion of the proximal box incrementally using a dental composite.

14. The method of claim 12, wherein the step of decoupling the dentin-bonded resin from the enamel bonded resin comprises waiting thirty minutes to two weeks.

15. The method of claim 12, further comprising the step of:
removing portions of the central dentin that are stained with a deep stain indicative of decay; and
leaving intact portions of the central dentin that are stained with a light haze such that said pulp remains unexposed.

16. The method of claim 12, further comprising using a light probe to measure a level of the stain.

17. The method of claim 12, further comprising applying a direct restoration only if an isthmus width of the tooth is about two millimeters or less.

18. The method of claim 17, further comprising applying a direct restoration only if an estimated cusp thickness is no less than about three millimeters.

19. The method of claim 18, further comprising applying a direct restoration only if a proximal box depth is less than about four millimeters.

20. The method of claim 12, further comprising applying an indirect or semi-direct restoration if an isthmus width of the tooth greater than about two millimeters.

21. The method of claim 20, further comprising applying an indirect or semi-direct restoration if an estimated cusp thickness of the tooth is less than about three millimeters.

22. The method of claim 21, further comprising applying an indirect or semi-direct restoration if a proximal box depth is greater than about four millimeters.

23. The method of claim 12, further comprising reducing compromised cusps occlusally.

24. The method of claim 12, further comprising treating carious dentin proximate the pulp with silver fluoride.

25. A method of restoring a tooth, said method comprising the steps of:
applying a direct restoration only if: an isthmus width of the tooth is about two millimeters or less, an estimated cusp thickness of the tooth is no less than about three millimeters, and a proximal box depth of the tooth is less than about four millimeters.

26. The method of claim 25, further comprising applying a caries detecting stain to a central dentin of the tooth, said central dentin of the tooth being disposed over a pulp of the tooth.

27. The method of claim 26, further comprising removing portions of the central dentin that are stained with a deep stain indicative of decay.

28. The method of claim 24, further comprising leaving intact portions of the central dentin that are stained with a light haze such that said pulp remains unexposed.

29. The method of claim 25, further comprising the step of removing all cracks into dentin of the tooth.

30. A method of restoring a tooth, said tooth comprising a pulp, enamel and central dentin, said central dentin of the tooth being disposed over the pulp of the tooth, said method comprising the steps of:
applying a caries detecting stain to the central dentin of the tooth to thereby form a staining pattern;
establishing a terminal depth of carious dentin removal for the central dentin based upon said staining pattern;
and removing the carious dentin above the terminal depth.

31. The method of claim 30, wherein said terminal depth of carious dentin removal is located between a deep stain indicative of decay and a light haze in the central dentin.

32. The method of claim 30, further comprising applying a silver fluoride solution to carious dentin below the terminal depth.

33. The method of claim 30, wherein the step of establishing a terminal depth of carious dentin removal comprises utilizing a cavity detecting probe.

34. The method of claim 33, wherein said cavity detecting probe comprises a light source.

35. The method of claim 34, wherein said light source is a laser.

36. The method of claim 33, wherein said cavity detecting probe comprises a light sensor for detecting fluorescence.

37. The method of claim 30, further comprising applying a direct restoration only if an isthmus width of the tooth is about two millimeters or less.

38. The method of claim 37, further comprising applying a direct restoration only if an estimated cusp thickness is no less than about three millimeters.

39. The method of claim 38, further comprising applying a direct restoration only if a proximal box depth is less than about four millimeters.

40. The method of claim 30, further comprising applying an indirect or semi-direct restoration if an isthmus width of the tooth greater than about two millimeters.

41. The method of claim 40, further comprising applying an indirect or semi-direct restoration if an estimated cusp thickness of the tooth is less than about three millimeters.

42. The method of claim 41, further comprising applying an indirect or semi-direct restoration if a proximal box depth is greater than about four millimeters.

43. The method of claim 30, further comprising the step of removing portions of the central dentin that are stained with a deep stain indicative of decay.

44. The method of claim 30, further comprising leaving intact portions of the central dentin that are stained with a light haze such that said pulp remains unexposed.

45. The method of claim 30, further comprising the steps of:
bonding a resin to the central dentin;
bonding a resin to the enamel; and
decoupling the dentin-bonded resin from the enamel-bonded resin.

46. The method of claim 45, wherein the step of decoupling the dentin-bonded resin from the enamel bonded resin comprises waiting thirty minutes to two weeks.

47. The method of claim 45, further comprising the step of deactivating applying chlorhexidine to the tooth.

48. The method of claim 30, further comprising the step of coupling a direct restoration to the tooth.

49. The method of claim 30, further comprising the step of coupling an indirect restoration to the tooth.

50. The method of claim 30, further comprising the step of coupling a semi-direct restoration to the tooth.

51. A method of restoring a tooth, said tooth comprising a pulp, enamel and dentin, the dentin comprising a peripheral moat and central dentin, said method comprising the steps of:
applying a caries detecting stain to the central dentin of the tooth, said caries detecting stain forming a staining pattern comprising a deep stain indicative of carious dentin and a light haze;
establishing a terminal depth of carious dentin removal for the central dentin based upon said staining pattern, wherein said terminal depth of carious dentin removal is located between the deep stain indicative of decay and the light haze in the central dentin;
wherein said terminal depth is determined using a cavity detecting probe having a light source and a light detector;
removing portions of the central dentin that are stained with the deep stain indicative of decay and above the terminal depth such that the pulp is not exposed;
leaving intact portions of the central dentin that are stained with the light haze such that said pulp remains unexposed;
applying a silver fluoride solution to any carious dentin below the terminal depth;
raising a portion of a proximal box incrementally using a dental composite;
applying a resin to the enamel;
applying a resin to the dentin;
decoupling the dentin-bonded resin from the enamel-bonded resin; and
coupling at least one of a direct, indirect or semi-direct restoration to the tooth.
